(19) United States
(12) Patent Application Publication
(10) Pub. No.: US 2015/0266579 A1
(43) Pub. Date: Sep. 24, 2015

(54) AUXILIARY STORAGE COMPARTMENT FOR AIRLINE PASSENGER CABINS

(71) Applicant: UMM AL-QURA UNIVERSITY, Makkah (SA)

(72) Inventor: ABDULMAJID MAAOD ALZAIDI, MAKKAH (SA)

(73) Assignee: UMM AL-QURA UNIVERSITY, Makkah (SA)

(21) Appl. No.: 14/218,866

(22) Filed: Mar. 18, 2014

(51) Int. Cl. B64D 11/00; B64D 45/00; E05F 15/60; B64D 25/00

(52) U.S. Cl. CPC B64D 11/003; B64D 25/00; B64D 11/0015; B64D 45/00; E05F 15/60; B64D 2231/025; B64D 2045/009

(57) ABSTRACT

The auxiliary storage compartment for airline passenger cabins is installed between conventional overhead baggage bins in an airline passenger aircraft. The compartment has a slide-up door that forms the floor and one wall of the compartment when the door is closed. When the door is raised, any article(s) therein automatically deploy and fall from the compartment due to gravity. The compartment may contain a fire retardant blanket, first aid kit, or other article(s). The door is lifted automatically by a motor that draws a tensile cable upward upon demand, the distal end of the cable being attached to the upper portion of the door. Detection of a passenger cabin fire or smoke triggers an audible alarm, with a sensor receiving the audible signal to actuate the motor and draw the door upward. The door may be lifted manually by a recessed handle in the lower outer portion of the door.

### BACKGROUND OF THE INVENTION

1. Field of the Invention

The present invention relates generally to storage drawers, compartments, and the like, and particularly to an auxiliary storage compartment or bin for airline passenger cabins. The compartment or bin is installed between the existing conventional overhead baggage compartments and may contain a fire suppression blanket, first aid kit, or other article(s) for automatic deployment in the event of a cabin fire.

2. Description of the Related Art

Overhead storage bins or compartments are a well-known, conventional feature of virtually all airline passenger aircraft. These bins or compartments provide for the storage of passenger carryon luggage and articles during flight, and provide for the convenient access of such articles during flight and when departing the aircraft at the end of a flight.

While such bins are often used to store airline-supplied conveniences such as blankets and pillows, they are not used for the storage of emergency equipment. Rather, airlines are required by federal regulation to carry an emergency medical kit and an unspecified number of first aid kits in the passenger cabin, depending upon the passenger capacity of the aircraft (14 CFR 121.309). These first aid kits are generally located at a relatively few stations aboard the aircraft, and are generally initially accessible only by cabin crewmembers (flight attendants). These kits are not automatically deployed, but must be manually accessed.

Airlines are also required to provide emergency oxygen for passengers depending upon the aircraft configuration, flight altitude, and flight duration at altitude (14 CFR 121.327-0.333). These emergency oxygen systems are generally in the form of individual simple continuous flow oxygen masks that drop from dedicated overhead panels above each seat in the event of cabin depressurization. The masks are deployed simultaneously throughout the passenger cabin, but there is no automated audible warning at the time of their deployment. Any such warning is issued verbally by the cabin crew.

Thus, an auxiliary storage compartment for airline passenger cabins solving the aforementioned problems is desired.

### SUMMARY OF THE INVENTION

The auxiliary storage compartment or bin for airline passenger cabins is installed between each of the conventional overhead baggage compartments or bins in an airline passenger aircraft. The compartment or bin has a slide-up door that forms the bottom and one side wall of the compartment when closed. An article of emergency equipment may be stored within the compartment, with the emergency equipment falling free due to gravity when the slide-up door is raised. The emergency equipment may comprise a fire retardant blanket, a first aid kit, or other article(s) as desired.

The curved slide-up door of the compartment or bin travels upward between tracks disposed along each of its lateral edges, when the door is raised. The door is lifted automatically by a motor that draws a tensile cable upward upon demand, with the distal end of the cable being attached to the upper portion of the door. Detection of a passenger cabin fire or smoke in the cabin triggers an audible alarm, with a sensor receiving the audible signal to actuate the motor and thereby draw the door upward. The door may be lifted manually by means of a recessed handle in the lower outer portion of the door, with the extended actuation cable flexing to allow the door to be raised.

These and other features of the present invention will become readily apparent upon further review of the following specification and drawings.

### BRIEF DESCRIPTION OF THE DRAWINGS

FIG. 1 is an environmental, perspective view of a portion of an airline passenger cabin showing a plurality of auxiliary storage compartments for airline passenger cabins according to the present invention.

FIG. 2 is an elevation view in section showing a closed auxiliary storage compartment for airline passenger cabins according to the present invention, with a fire suppression blanket folded therein.

FIG. 3 is an elevation view in section showing an open auxiliary storage compartment for airline passenger cabins according to the present invention, showing the fire suppression blanket falling freely therefrom.

FIG. 4 is an elevation view in section showing a closed auxiliary storage compartment for airline passenger cabins according to the present invention, showing its use for the containment of a first aid kit.

FIG. 5 is a block diagram illustrating the basic components of the automated actuating system for the auxiliary storage compartment for airline passenger cabins according to the present invention.

Similar reference characters denote corresponding features consistently throughout the attached drawings.

### DETAILED DESCRIPTION OF THE PREFERRED EMBODIMENTS

The auxiliary storage compartment for airline passenger cabins includes a compartment or bin disposed between otherwise adjacent conventional overhead storage compartments in an airline passenger cabin. The auxiliary compartment may be opened automatically upon receipt of an audible signal warning of smoke or fire in the passenger cabin, to deploy a fire retardant blanket or other emergency equipment stowed therein. The compartment may be opened manually as well, and may be used for the storage of other articles.

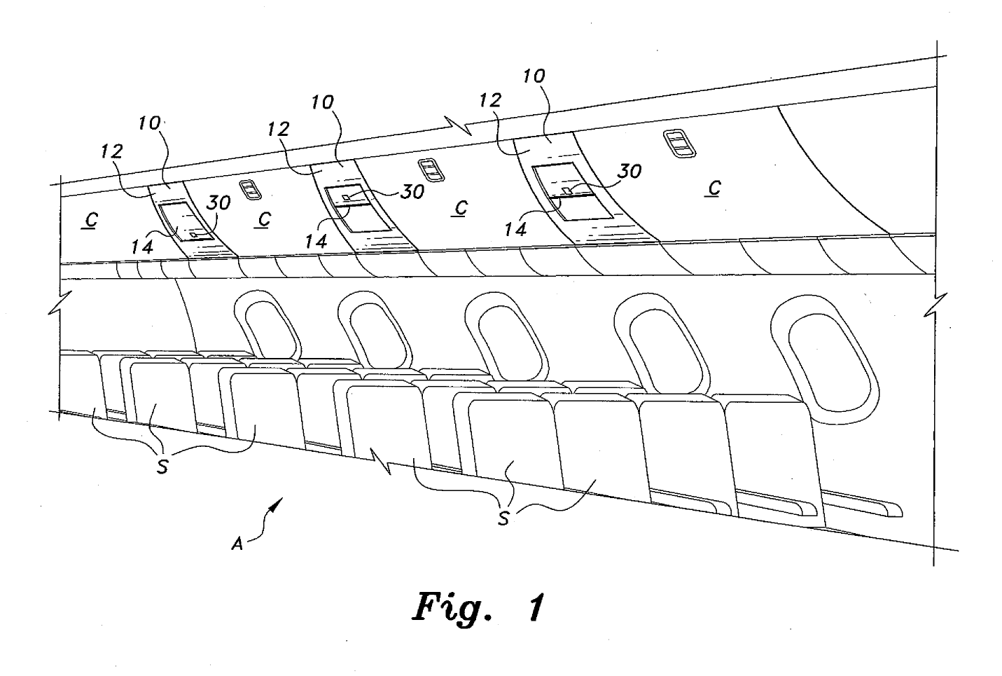

FIG. 1 of the drawings is an environmental perspective view of a portion of an exemplary airline passenger cabin A, with a series of conventional overhead storage compartments C located above the passenger seats S. An auxiliary overhead storage compartment or bin 10 may be located between otherwise adjacent conventional compartments C, resulting in a plurality of such auxiliary compartments or bins 10 in the passenger cabin A. Each auxiliary compartment or bin 10 includes an outwardly curved wall 12 having a substantially congruent sliding door 14 therein, with the door 14 encompassing substantially the majority of the area of the curved wall 12. The curvature of the wall 12 and door 14 results in the door 14 defining the front wall and floor of the compartment or bin 10 when the door is closed.

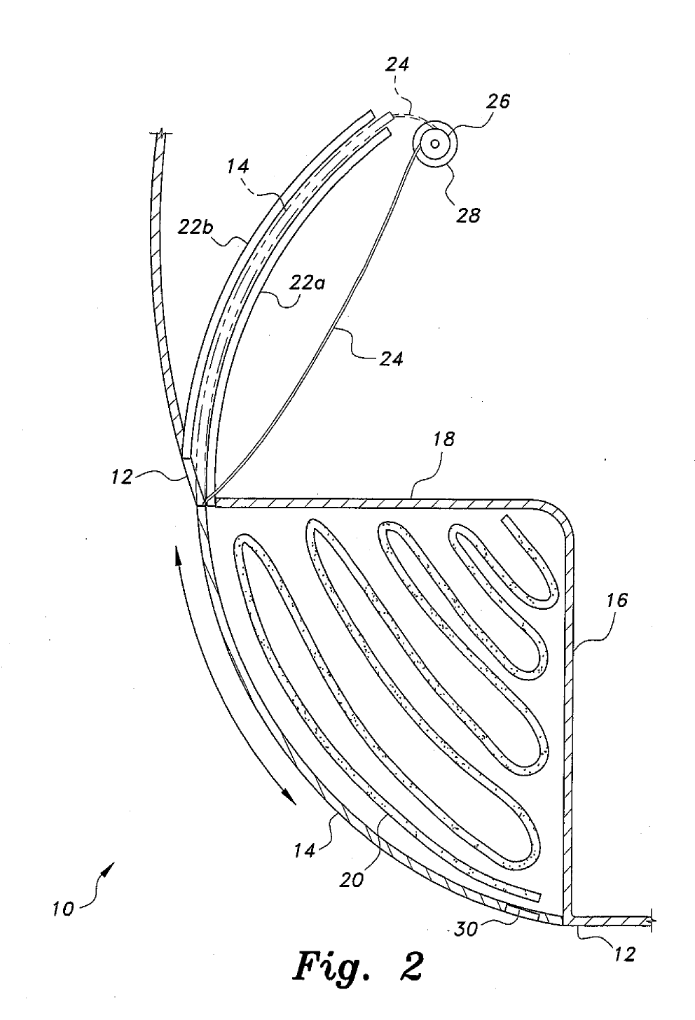

FIG. 2 of the drawings is an elevation view in section through one of the auxiliary storage compartments or bins 10. The compartment or bin 10 further includes a fixed back wall 16 and a fixed upper wall 18, with the curved door 14 forming substantially the majority of the floor and front wall, i.e., that surface that faces toward the center of the passenger cabin, as noted further above. In the example of FIG. 2, a fire retardant blanket 20 is stowed within the compartment or bin 10. The blanket 20 may be formed of any of a number of suitable fire resistant or retardant fabric materials, e.g., aramid fibers such as Nomex®, etc.

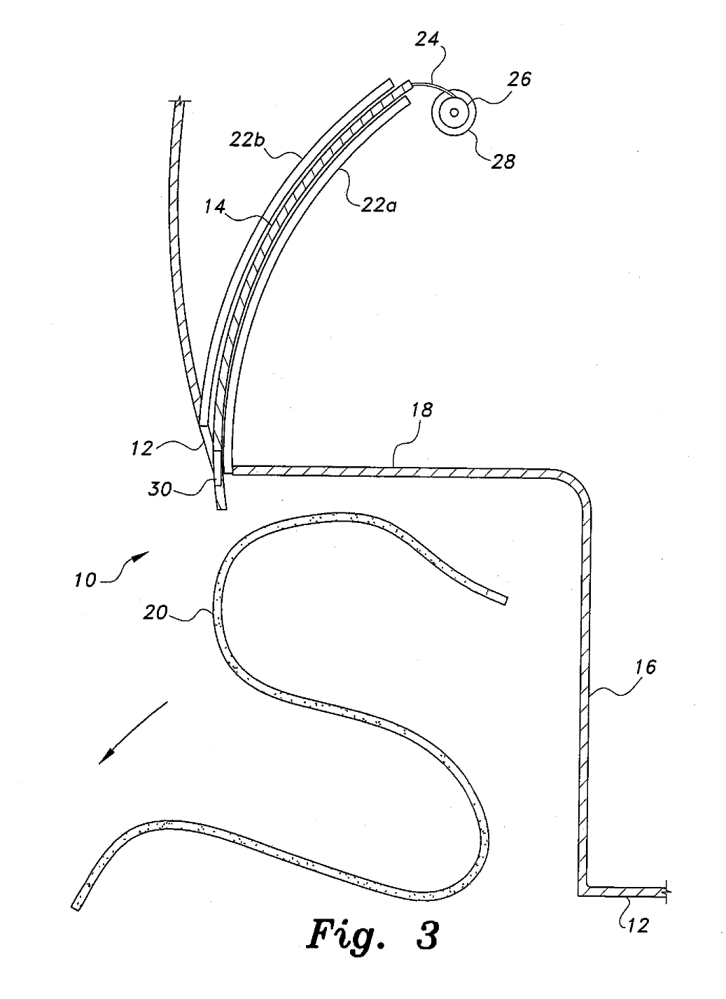

FIG. 3 of the drawings provides an elevation view in section of the auxiliary storage compartment 10 with its slide-up door 14 in an open position. As the door 14 normally defines the floor and front wall of the compartment or bin 10, sliding the door 14 upwardly essentially results in the removal of the floor and front wall of the bin 10. This allows any article stowed therein, e.g., the fire retardant blanket 10, to automatically fall freely from the compartment or bin 10 due to gravity, essentially as depicted in FIG. 3. No additional mechanism is required to deploy the blanket 20 (or other article stowed within the bin 10) from the bin 10 when the door 14 is fully opened, as shown in FIG. 3.

The door 14 of the auxiliary storage compartment 10 is configured to open automatically upon receipt of an audible warning. Any suitable mechanism may be employed to activate the door once the audible warning is issued. An exemplary door actuating mechanism is illustrated in FIGS. 2 and 3 of the drawings. As shown in FIGS. 2 and 3, the sliding door 14 may be guided by inner and outer door guide tracks, respectively 22a and 22b, disposed at each lateral edge of the door 14. The door guide tracks 22a, 22b conform to the curvature of the door 14 for smooth operation. A flexible cable 24 is attached to the uppermost edge or portion of the door 14, with the cable 24 being deployed from a reel 26 that is attached to and driven by a door lifting motor 28. The door lifting motor 28 is activated by a sensor receiving an audible signal after the presence of smoke or fire is detected. Actuation of the motor 28 places the flexible cable 24 in tension as the cable reel 26 winds the cable 24 around the reel 26, thereby lifting the door 14 from its normally closed position as shown in FIG. 2 to its opened position as shown in FIG. 3 to deploy the blanket 20 or other article(s) stowed within the compartment or bin 10.

As the door lifting cable 24 is flexible, it will be seen that the door 14 may be lifted manually even though the motor 28 is not actuated. This may be accomplished by means of the recessed manual lift handle or hand hold 30 provided near the lowermost edge of the door 14. When the door 14 is opened manually, the flexible cable 24 merely flexes or sags downward between the cable reel 26 and the upper edge of the door 14. When the door 14 is lowered manually, the cable 24 is again extended between the reel 26 and the lowered upper edge of the door 14, ready for automatic operation.

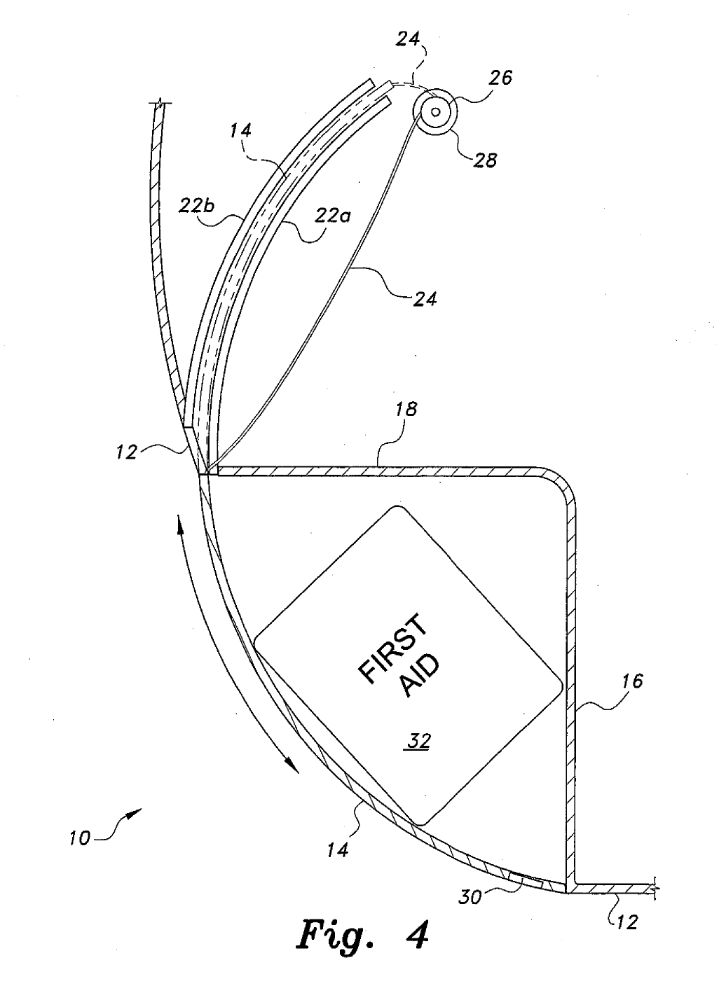

FIG. 4 provides an elevation view in section of the auxiliary storage compartment or bin 10, showing its use in stowing an article other than the fire retardant blanket 20. The storage compartment or bin 10 configuration shown in FIG. 4 is essentially the same as that shown in FIG. 2, i.e., with the door 14 closed, but a first aid kit 32 is stored within the compartment or bin 10 in FIG. 4, rather than a fire retardant blanket. It will be seen that depending upon the internal volume of the compartment or bin 10 and the volume required for storage of such articles as the blanket 20 and first aid kit 32, a plurality of such articles or other articles might be stored within the auxiliary storage compartment or bin 10. For example, a larger medical kit, smoke protection hood, and/or various non-emergency comfort and convenience articles might be stored within the auxiliary storage compartment or bin 10, as desired.

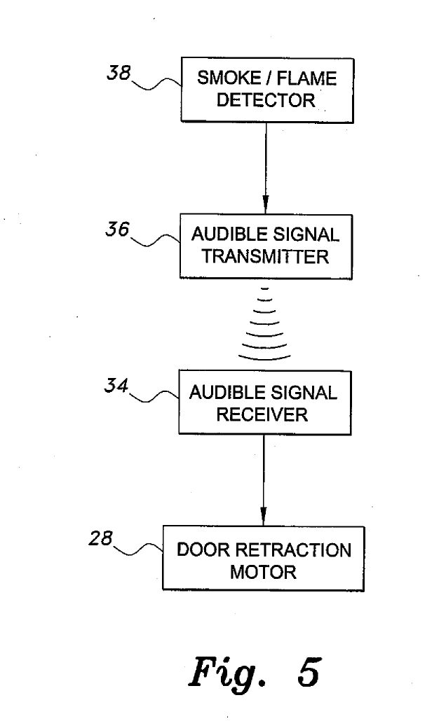

FIG. 5 of the drawings provides a block diagram illustrating the basic components of the automatic operating system for the auxiliary storage compartment 10 or the auxiliary storage compartment system. The door retraction or door lift motor 28 of the auxiliary storage compartment 10 is actuated by an audible signal receiver 34 of the auxiliary storage compartment 10, which communicates electrically with the motor 28 in a conventional manner. The receiver 34 is capable of receiving an audible signal from an audible signal transmitter 36, e.g., a sound emitting device that produces a distinctive emergency sound that is capable of being received by the audible signal receiver 34. The transmitter 36 in turn communicates electronically with a conventional smoke and/or flame detector 38 and is activated upon detection of smoke or flame by the detector 38. The smoke and/or flame detector 38 and the audible signal transmitter 36 may be related components contained within a single housing or unit, as in a conventional smoke detector and alarm.

In the event of a cabin fire or smoke emission within the aircraft, the smoke and/or flame detector 38 senses such and automatically produces an audible alarm that is emitted or transmitted from the audible signal transmitter 36. The audible sound produced by the transmitter 36 is received by the audible signal receiver 34, which in turn automatically actuates the sliding door 14 of the auxiliary storage compartment or bin 10 to drop any article(s) therefrom that might be contained within the compartment or bin 10. It should be understood that a relatively large number of such storage compartments or bins 10 may be opened by the receipt of an audible signal from a single transmitter 36. Preferably, there are a plurality of smoke and/or flame detectors 38 located in various areas of the passenger cabin, in order to promptly detect smoke and/or flame at any given part of the cabin. Any one of the smoke and/or flame detectors that is activated, can transmit an audible signal that will be received by all of the receivers 34 to actuate all of the door lift or door retraction motors 28, thereby opening all of the doors 14 of all of the auxiliary compartments or bins 10.

It is to be understood that the present invention is not limited to the embodiments described above, but encompasses any and all embodiments within the scope of the following claims.

I claim:

1. An auxiliary storage compartment for airline passenger cabins, comprising:
a storage bin, having:
a fixed back wall;
a fixed upper wall; and
an outwardly curved sliding door, the door defining the front wall and floor of the bin when closed.

2. The auxiliary storage compartment for airline passenger cabins according to claim 1, further comprising:
a door lifting motor for selectively lifting the door when the motor is actuated; and
an audible signal receiver, wherein the audible signal receiver is in electrical communication with an audible signal transmitter and the door lifting motor, the audible signal receiver actuating the door lifting motor when an audible signal is received from the transmitter.

3. The auxiliary storage compartment for airline passenger cabins according to claim 1 further comprising a plurality of door guide tracks communicating with the door, the tracks being configured for guiding the door between closed and open positions.

4. The auxiliary storage compartment for airline passenger cabins according to claim 1, further comprising:
a door lifting motor;
a cable reel extending from the motor; and
a flexible tensile cable extending from the reel to the door, whereby actuation of the motor winds the cable upon the reel, the cable drawing the door from a closed position to an open position.

5. The auxiliary storage compartment for airline passenger cabins according to claim 1, further comprising an article of emergency equipment disposed within the bin, the article of emergency equipment being selected from the group consisting of a fire retardant blanket and a first aid kit.

6. The auxiliary storage compartment for airline passenger cabins according to claim 1, further comprising a recessed manual lift handle disposed within the door.

7. A plurality of auxiliary storage compartments for airline passenger cabins, comprising:
a plurality of storage bins, each of the bins being disposed between two overhead storage compartments in the airline passenger cabin, each storage bin having a fixed back wall, a fixed upper wall, an outwardly curved sliding door, the door defining the front wall and floor of the bin when closed.

8. The plurality of auxiliary storage compartments for airline passenger cabins according to claim 7, wherein each storage bin further comprises:
a door lifting motor for selectively lifting the door when the motor is actuated; and
an audible signal receiver, wherein the audible signal receiver is in electrical communication with an audible signal transmitter and the door lifting motor, the audible signal receiver actuating the door lifting motor when an audible signal is received from the transmitter.

9. The plurality of auxiliary storage compartments for airline passenger cabins according to claim 7, wherein each storage bin further comprises a plurality of door guide tracks communicating with the door, the tracks being configured for guiding the door between closed and open positions.

10. The plurality of auxiliary storage compartments for airline passenger cabins according to claim 7, wherein each storage bin further comprises:
a cable reel extending from the door lifting motor; and
a flexible tensile cable extending from the reel to the door, whereby actuation of the motor winds the cable upon the reel, the cable drawing the door from a closed position to an open position.

11. The plurality of auxiliary storage compartments for airline passenger cabins according to claim 7, further comprising an article of emergency equipment disposed within each bin, the article of emergency equipment being selected from the group consisting of a fire retardant blanket and a first aid kit.

12. The plurality of auxiliary storage compartments for airline passenger cabins according to claim 7, wherein each storage bin further comprises a recessed manual lift handle disposed within the door.

13. An auxiliary storage compartment system for airline passenger cabins, comprising:
at least one storage bin, the at least one storage bin having:
a fixed back wall,
a fixed upper wall,
an outwardly curved sliding door, the sliding door defining a movable floor and wall of the bin when the door is closed,
a door lifting motor for selectively lifting the door when the motor is actuated, and
an audible receiver;
an audible signal transmitter; and
a detector in electrical communication with the audible signal transmitter and configured to activate the audible signal transmitter,
wherein the audible signal receiver is in electrical communication with an audible signal transmitter and the door lifting motor, the audible signal receiver actuating the door lifting motor when an audible signal is received from the transmitter.

14. The auxiliary storage compartment for airline passenger cabins according to claim 13, wherein the audible signal transmitter and the detector are within a single housing.

15. The auxiliary storage compartment for airline passenger cabins according to claim 13, further comprising:
a plurality of door guide tracks communicating with the door, the tracks being configured for guiding the door between closed and open positions;
a door lifting motor;
a cable reel extending from the motor; and
a flexible tensile cable extending from the reel to the door, whereby actuation of the motor winds the cable upon the reel, the cable drawing the door from a closed position to an open position along the tracks.

16. The auxiliary storage compartment for airline passenger cabins according to claim 13, further comprising an article of emergency equipment disposed within the bin, the article of emergency equipment being selected from the group consisting of a fire retardant blanket and a first aid kit.

17. The auxiliary storage compartment for airline passenger cabins according to claim 13, further comprising a recessed manual lift handle disposed within the door.

18. The auxiliary storage compartment for airline passenger cabins according to claim 13, wherein the at least one storage bin includes a plurality of storage bins, each of the bins being disposed between two overhead storage compartments in the airline passenger cabin.
